(19) United States
(12) Patent Application Publication
(10) Pub. No.: US 2009/0261675 A1
(43) Pub. Date: Oct. 22, 2009

(54) HIGH EFFICIENT MAGNETIC ENERGY SHIFTING DEVICE

(76) Inventors: Hsien-Wei Hsiao, Tanzih Township (TW); Yu-Wei Fan, Tanzih Township (TW); Kuan-Jung Liu, Tanzih Township (TW)

Correspondence Address: SINORICA, LLC, 2275 Research Blvd., Suite 500, ROCKVILLE, MD, 20850, US

(21) Appl. No.: 12/106,292

(22) Filed: Apr. 19, 2008

(51) Int. Cl. H02K 21/12; H02K 1/22

(52) U.S. Cl. 310/156.01; 310/268

(57) ABSTRACT

A high efficient magnetic energy shifting device includes at least a magnetism unit consisting of plural induction coils and at least a magnetic element. Each of the induction coils is provided with plural individual coils formed by having wire coaxially wound in a same direction, an opening formed in the center of the individual coils and an induction stage formed around the outer surface of the individual coils. The induction coils are successively arrayed and fixed stably by positioning elements. The magnetic element is located at a position corresponding to a maximal surface of the induction stage so as to create a high voltage in a same unit area or kinetic energy under a low current, achieving a purpose of high efficient energy shift.

### BACKGROUND OF THE INVENTION

1. Field of the Invention

This invention relates to a magnetic energy shifting device, particularly to one able to efficiently transit power to a driving device.

2. Description of the Prior Art

Commonly, in a proper combination of a coil and a magnet, magnetic energy can be created by induction interacted between different poles of the magnets and the coils. That is applied for dynamoelectric machines with a direction-shifting brush in the past, as disclosed in U.S. Pat. No. 3,988,024, U.S. Pat. No. 4,361,776, U.S. Pat. No. 4,371,801 and U.S. Pat. No. 5,146,144. The conventional motor generally includes magnetic rotor disc alternately disposed with N-pole and S-pole pieces and rotating above and below plural stator coils arrayed together on a same level. Current flowing in the conductor wires of the coils interacts with the alternating magnet flux lines of the disc producing Lorents forces perpendicular to the radially directioned conductors and thus tangential to the axis of rotation. While current flows through the entire coils, only the radial extending portions of the conductors (called working conductors) contribute to torque to the rotor. As for those disclosed in U.S. Pat. No. 4,068,143, U.S. Pat. No. 4,420,875, U.S. Pat. No. 4,551,645 and U.S. Pat. No. 4,743,813, while they have the conductors closely arranged, but a gap between the magnets of the rotors and the magnetic flux density are about twice as the thickness of a non-overlapped coil, posing a low magnetic flux density and accordingly lessen the efficiency of a motor.

In addition, as disclosed in U.S. Pat. No. 5,744,896, it is provided with a plurality of coils alternately overlaid to form a slender toroidal array, having a double density of the non-overlapped coils array. However, a gap still exists between the adjacent overlap, reducing the magnetic energy shifting efficiency for a motor. Moreover, the coils must be shaped in a preset one before wound with wire, necessitating a complicated and a costly manufacturing process.

### SUMMARY OF THE INVENTION

The object of this invention is to offer a high efficient magnetic energy shifting device.

The high efficient magnetic energy shifting device includes at least a magnetism unit consisting of plural induction coils and at least a magnetic element. Each of the induction coils is provided with plenty of individual coils formed by having wire coaxially wound in a same direction, an opening formed in the center of the individual coils and an induction stage formed around the outer surface of the individual coils. The induction coils are successively arrayed and fixed together by positioning elements. The magnetic element is located at a position corresponding to a maximal surface of the induction stage so as to create a high voltage in a same unit area or kinetic energy under a low current, achieving a purpose of high efficient energy shift.

### BRIEF DESCRIPTION OF DRAWINGS

This invention is better understood by referring to the accompanying drawings, wherein:

FIG. 1 is a perspective view of a first preferred embodiment of a high efficient magnetic energy shifting device in the present invention;

FIG. 2 is a partial top view of the first preferred embodiment of a high efficient magnetic energy shifting device in the present invention;

FIG. 3 is a perspective view of a second preferred embodiment of a high efficient magnetic energy shifting device in the present invention;

FIG. 4 is a partial magnified side view of the second preferred embodiment of a high efficient magnetic energy shifting device in the present invention;

FIG. 5 is a side cross-sectional view of the second preferred embodiment of a high efficient magnetic energy shifting device in the present invention;

FIG. 6 is another side cross-sectional view of the second preferred embodiment of a high efficient magnetic energy shifting device in the present invention;

FIG. 7 is a perspective view of a third preferred embodiment of a high efficient magnetic energy shifting device in the present invention;

FIG. 8 is a side cross-sectional view of the third preferred embodiment of a high efficient magnetic energy shifting device in the present invention;

FIG. 9 is a top view of a fourth preferred embodiment of a high efficient magnetic energy shifting device in the present invention;

FIG. 10 is a side cross-sectional view of a fifth preferred embodiment of a high efficient magnetic energy shifting device in the present invention;

FIG. 11 is a top view of a sixth preferred embodiment of a high efficient magnetic energy shifting device in the present invention;

FIG. 12 is a top view of a seventh preferred embodiment of a high efficient magnetic energy shifting device in the present invention; and

FIG. 13 is a top view of an eighth preferred embodiment of a high efficient magnetic energy shifting device in the present invention.

### DETAILED DESCRIPTION OF THE PREFERRED EMBODIMENT

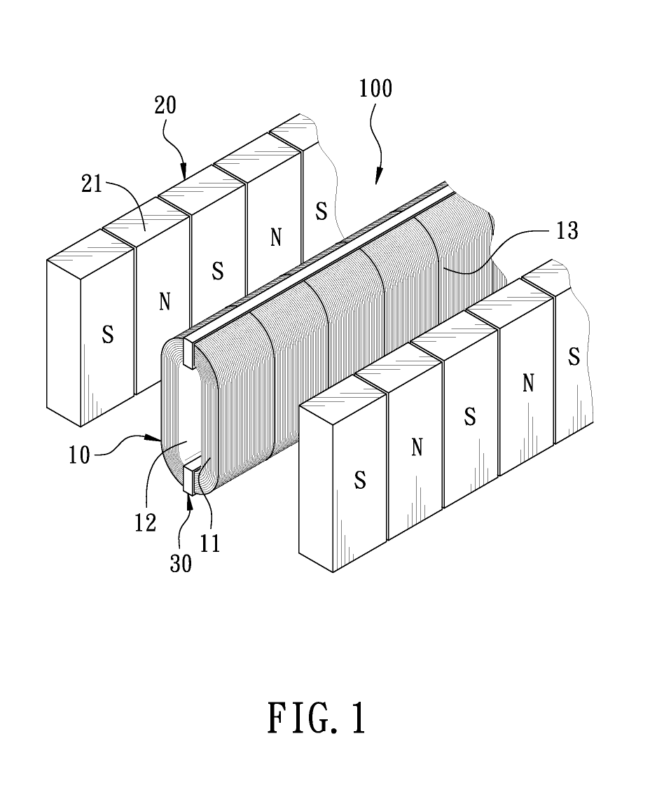

As shown in FIG. 1, a first preferred embodiment of a high efficient magnetic energy shifting device in the present invention includes a magnetism unit 100 and a driving device such as a dynamoelectric vehicle installed on a central shaft of the magnetism unit 100, or blades of a wind generator fixed around the circumference of the magnetism unit 100. The magnetism unit 100 is composed of plural induction coils 10 and two magnetic elements 20.

Each of the induction coils 10 is provided with a plurality of individual coils 11 formed by having wire coaxially and longitudinally wound in a same direction to become a slender ellipse or a rectangle, an opening 12 formed in the central portion of the individual coils 11, and an induction stage 13 fully formed around the outer circumference of the individual coils 11. An ellipse is selected as the shape of the individual coils 11 in this embodiment. The induction coils 10 are vertically arrayed together, having their upper and lower portion fixed together by two positioning elements 30.

Each of the magnetic elements 20 is composed of a plurality of magnetic plates 21 made of permanent magnet and aligned together to correlate to two corresponding sides of the induction stage 13 of the induction coils 10.

In order to further understand the structural features, operative techniques and expected effects of the invention, how to use the invention is to be described below

In operation, with the magnetic plates 21 corresponding to a maximal surface of the induction stage 13 of the individual coils 11 of the induction coils 10, an interactive induction can be created by the different poles of the magnetic plates 21 and the induction coil sets 10. And, with the induction coils 10 densely wound to enable the interactive induction enhanced between the induction stage 13 and the magnetic plates 21, the direction-changing shock caused when the magnetic plates 21 pass through the interface of every two adjacent induction stages 13 can be lowered to smoothen the whole operation. Moreover, a maximal induction surface can be obtained in per unit time between the magnetic plates 21 and the induction coils 10, providing a high efficient power shift for the driving device.

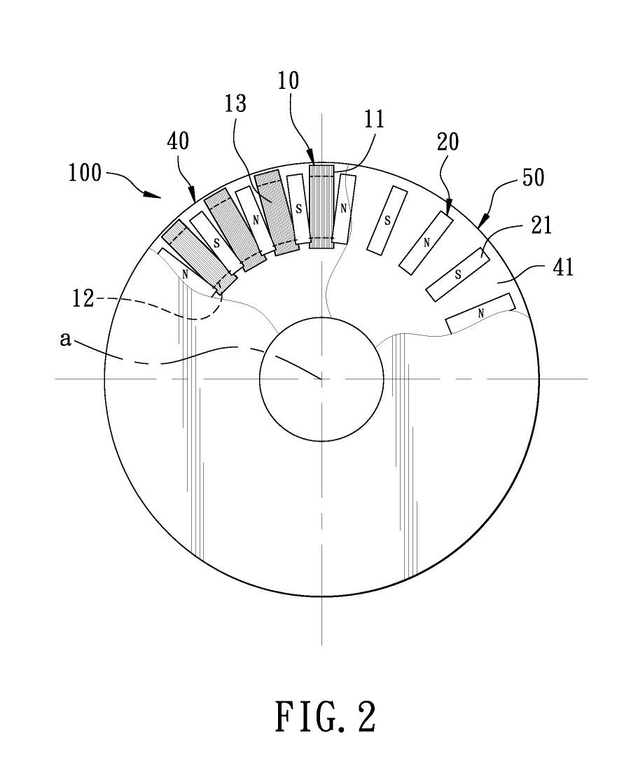

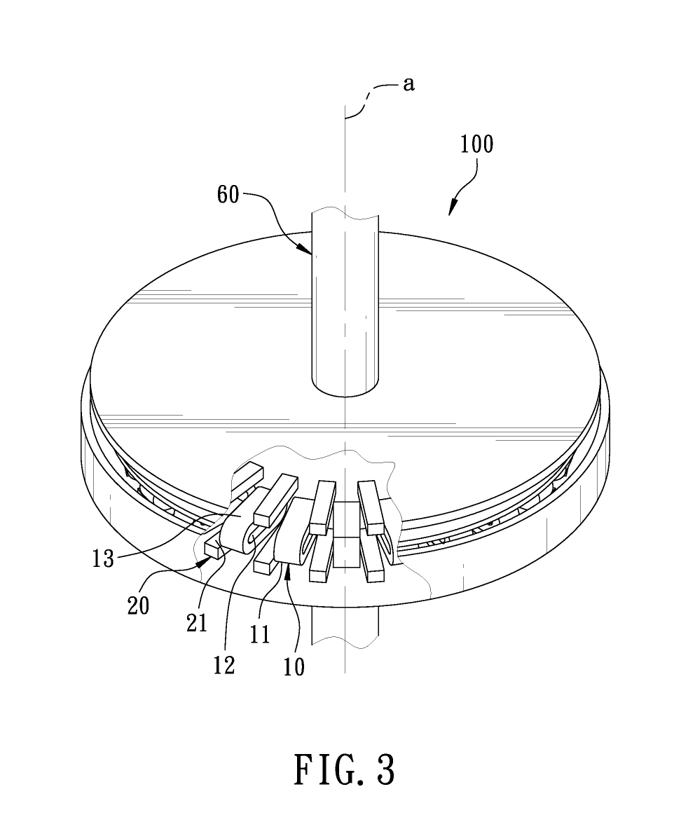

FIGS. 2 and 3 respectively show a partial top view and a perspective view of a second preferred embodiment of a high efficient magnetic energy shifting device in the present invention. Each of the induction coils 10 is provided with a plurality of individual coils 11 formed by having wire coaxially and longitudinally wound in a same direction to become a slender ellipse, an opening 12 formed in the central portion of the individual coils 11, and an induction stage 13 fully formed around the outer circumference of the individual coils 11. The induction coils 10 are vertically and circularly arrayed around a same central axis (a), spaced apart equidistantly. The central axis (a) is provided for being installed with a shaft 60 of the driving device.

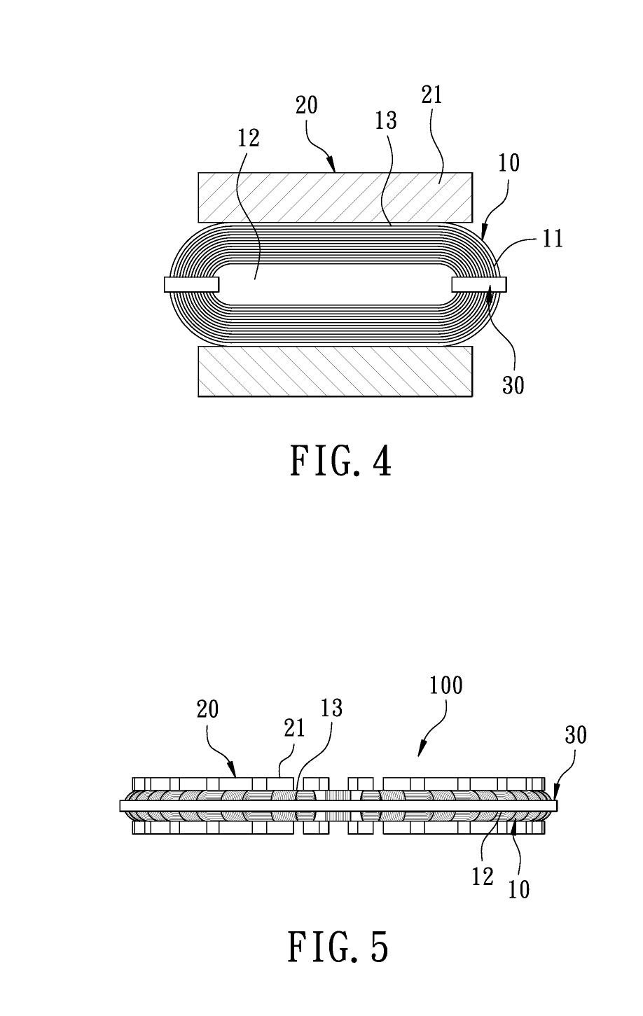

FIGS. 4 and 5 respectively show a partial magnified view and a side cross-sectional view of the second embodiment. The induction coils 10 are fixed stably together by the positioning elements 30. The magnetic elements 20 are respectively located above and below the induction coils 10, with each of the magnetic plates 21 exactly facing to the induction portion 13, enabling the magnetism unit 100 formed toroidal.

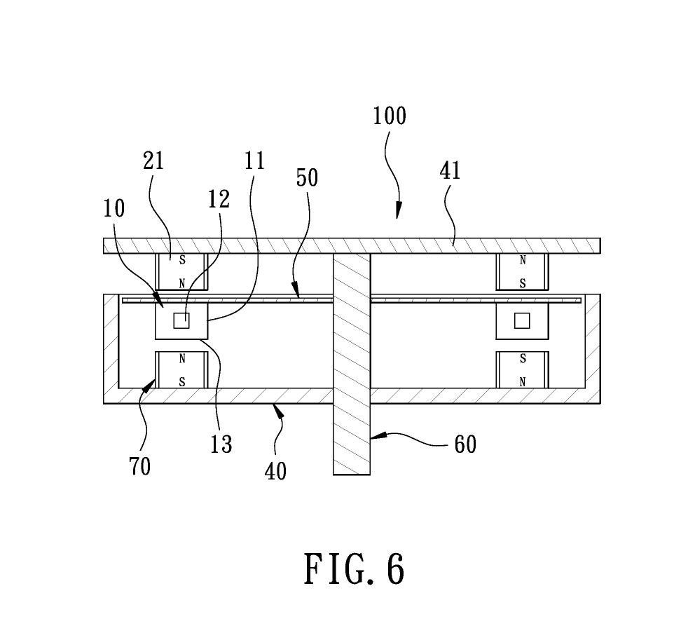

And, FIG. 6 shows a cross-sectional view of the second preferred embodiment, with the magnetism unit 100 connected with a dynamoelectric vehicle. The magnetic plates 21 have one side opposite to that corresponding to the top or the bottom of the induction coils 10 positioned on a rotary disc 40 and a sidewall of a first isolating board 41. The induction coils 10 are fixed on a second isolating board 50. The rotary disc 40, the first isolating board 41 and the second isolating board 50 are all coaxially bored with an opening for accommodating the shaft 60, so as to keep the rotary disc 40 and the first isolating board 41 able to whirl around the shaft 60, and the second isolating board 50 positioned stably on the shaft 60. Before fixed on the rotary disc 40 and the first isolating board 41, the magnetic plates 21 have their surface that does not facing to the induction stage 13 respectively wrapped with a shield 70 made of metal, so as to let magnetism concentrated on the maximal surface of the induction stages 13 of the individual coils 11 of the induction coils 10.

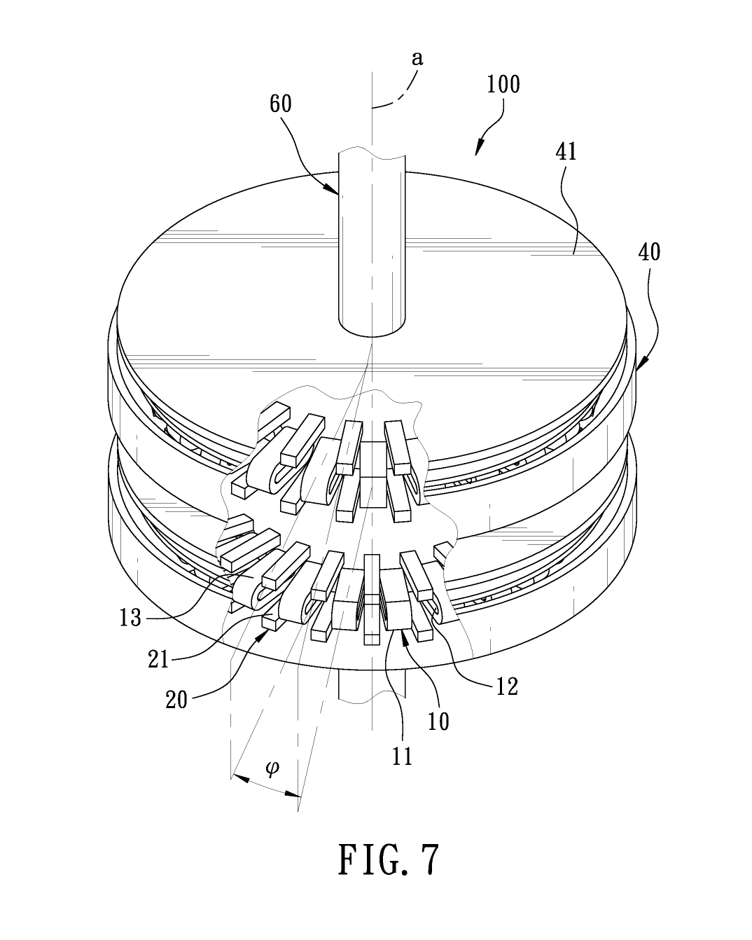

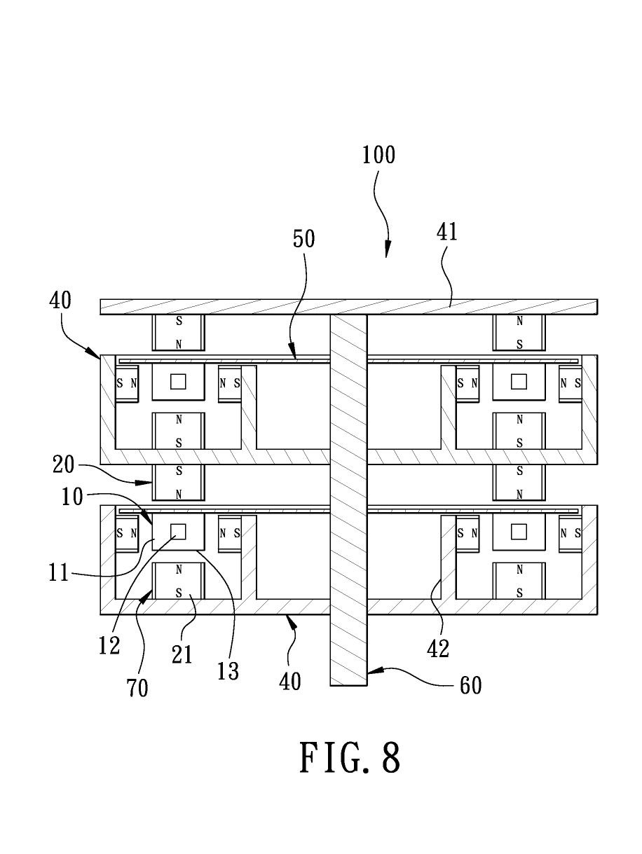

A third preferred embodiment of a high efficient magnetic energy shifting device in the present invention, as shown in FIGS. 7 and 8, includes two magnetism units 100 of the second embodiment mutually overlaid along the shaft 60, with the induction coils 10 of the magnetism units 100 alternately positioned with the magnetic plates 21 to form an alternate angle φ between every two adjacent induction coils 10 and the magnetic plate 21. The magnetic elements 20 are provided not only with the magnetic plates 21 corresponding to the top and the bottom of the induction stages 13 of the induction coil sets 10 with a maximal surface, but with those corresponding to the right and the left side of the induction stages 13 of the induction coils 10. The magnetic plates 21 corresponding to the top and the bottom of the induction stages 13 are fixed on the rotating disc 40 and the first isolating board 41, and those correlating to the right and the left side of the induction stages 13 are fixed on isolating boards 42 vertically located on the rotating disc 40. The induction coil sets 10 are fixed on the second isolating boards 50. Thus, the induction coil sets 10 are confined in an enclosed magnetic field surrounded by the magnetic plates 21 so as to be maximally induced.

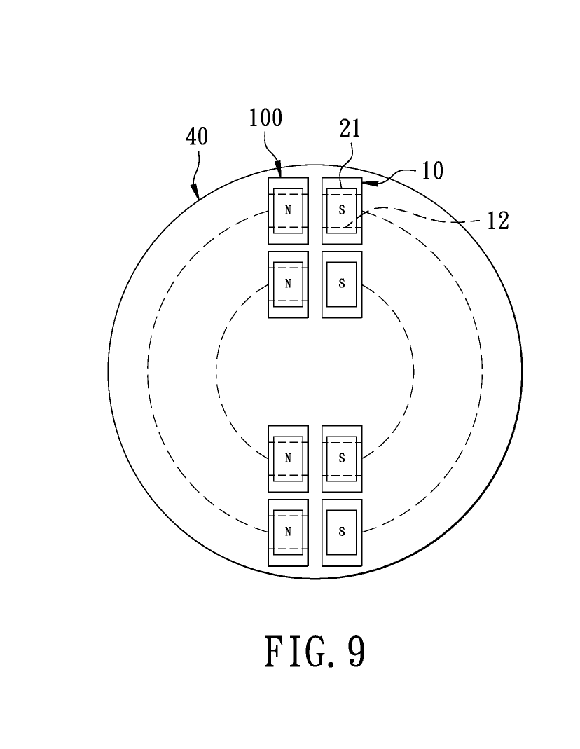

As shown in FIG. 9, a fourth preferred embodiment of a high efficient magnetic energy shifting device in the present invention includes also two magnetism units 100 of the second embodiment. One of the magnetism units 100 is formed into a small circle around the central axis (a), and the other into a large circle around the central axis (a) on a same level, just like two layers.

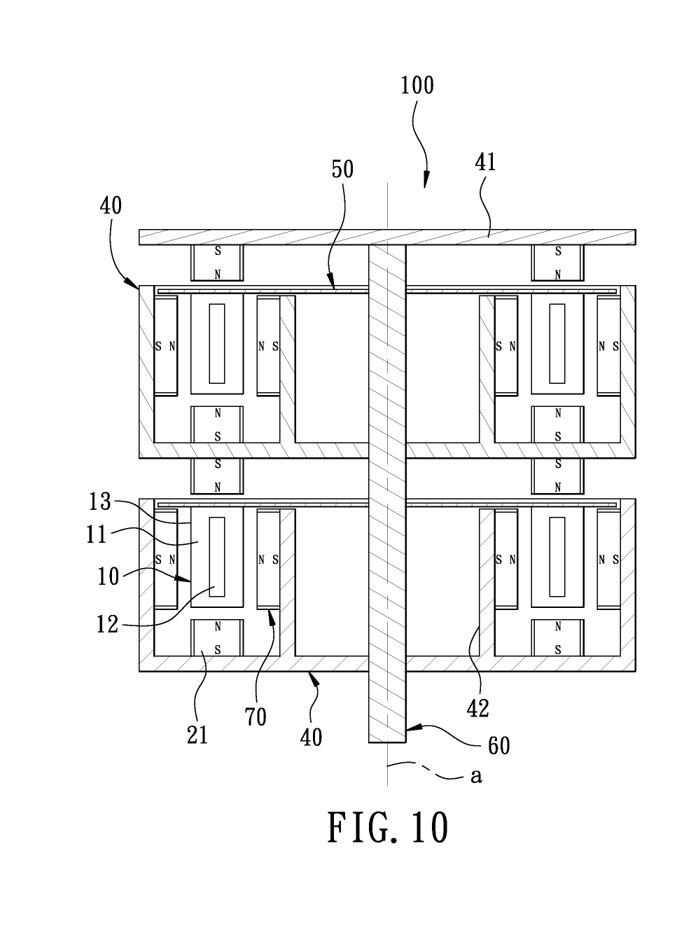

FIG. 10 shows a fifth preferred embodiment of a high efficient magnetic energy shifting device in the present invention. The induction coils 10 are respectively provided with a plurality of individual coils 11 formed by having wire coaxially and longitudinally wound in a same direction to become a slender ellipse, vertically arrayed around the central axis (a) equidistantly, with their long sides having a maximal surface of the induction stages 13 parallel to the central axis (a). Two magnetism units 100 are employed in the embodiment, mutually overlaid along the central axis (a) in plural layers and separated by the rotating disc 40. The magnetic plates 21 corresponding to the top and the bottom of the induction stages 13 are fixed on the rotating disc 40 and the first isolating board 41, and those correlating to the right and the left side of the induction stages 13 are fixed on isolating boards 42. The induction coils 10 are fixed on the second isolating boards 50. Thus, the induction coils 10 are as well confined in an enclosed magnetic field surrounded by the magnetic plates 21 so as to be maximally induced.

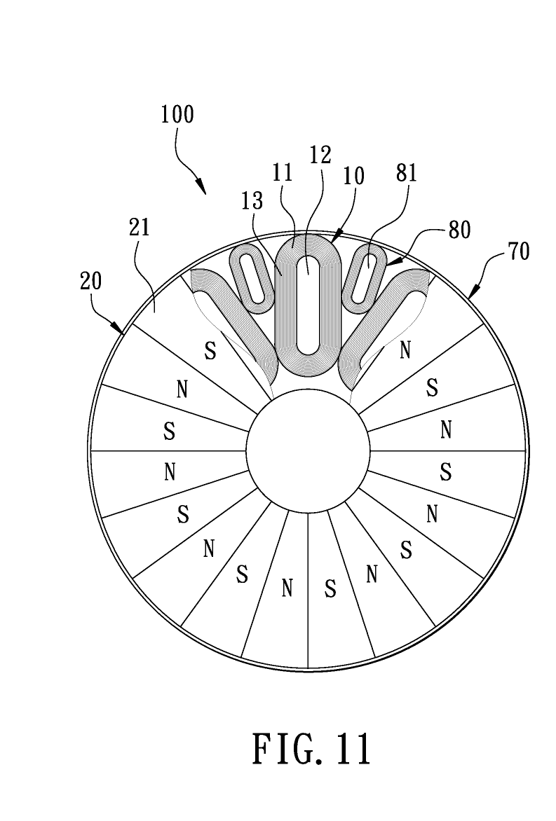

FIG. 11 shows a sixth preferred embodiment of a high efficient magnetic energy shifting device in the present invention. The induction coils 10 are respectively composed of a plurality of individual coils 11 formed by having wire coaxially and longitudinally wound in a same direction to become a slender ellipse, circularly arrayed around a central shaft 60 by having their axis aligned with the radius of the magnetism unit 100. An included angle is formed between every two adjacent induction coil 10, installed with a secondary induction coil 80. The magnetic elements 20 are positioned to correspond to the openings 12 of the induction coils 10 and the secondary induction coils 80, with the maximal surface of the induction stages 13 located at the top and the bottom of the induction coils 10 and the secondary induction coils 80 corresponding to the magnetic element 20. Each of the magnetic plates 21 has its surface without facing to the induction stage 13 wrapped with a shield 70.

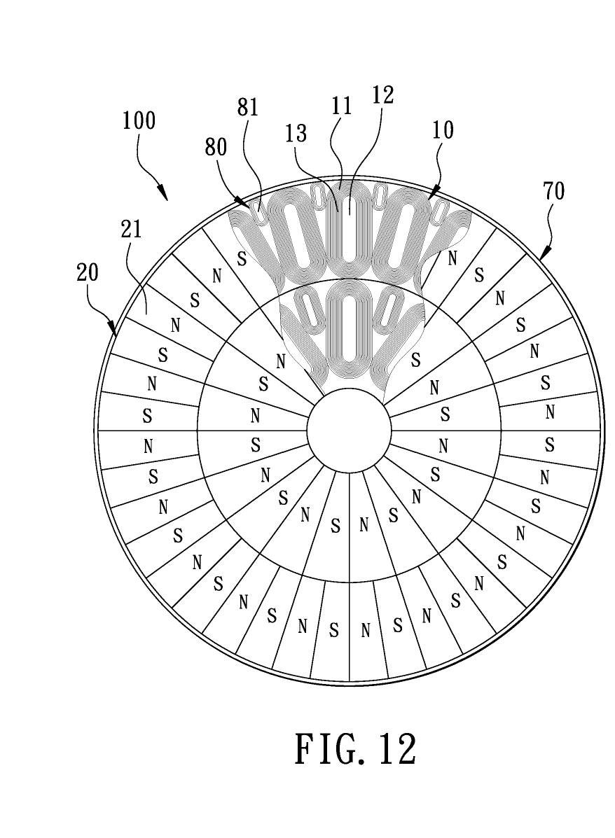

As shown in FIG. 12, a seventh preferred embodiment of a high efficient magnetic energy shifting device in the present invention includes two magnetism units 100 of the sixth embodiment. One of the magnetism units 100 is formed into a small circle around the central axis (a) and the other into a large circle around the central axis (a) on a same level.

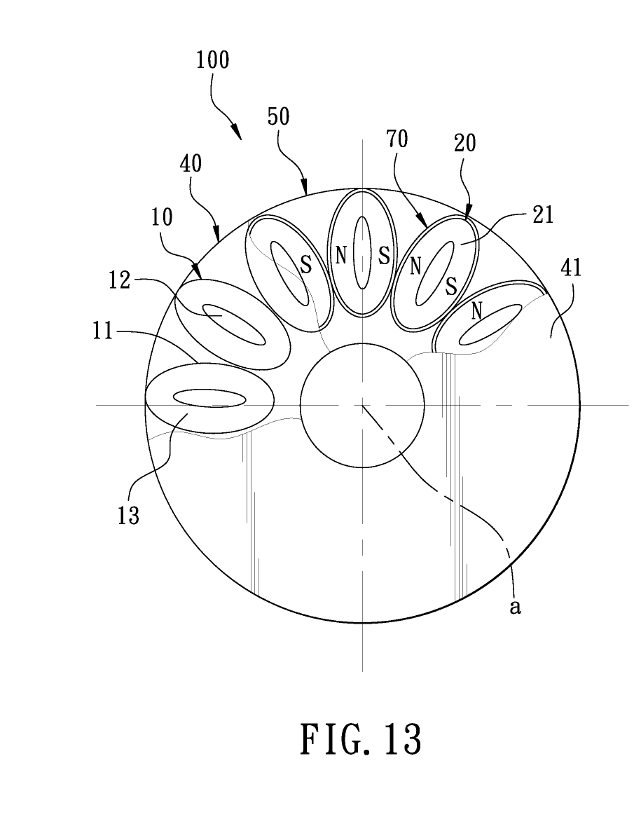

And, FIG. 13 shows an eighth preferred embodiment of a high efficient magnetic energy shifting device in the present invention. The induction coil sets 10 are longitudinally and circularly arrayed around a central shaft 60, with an included angle formed between every two of them adjacent. Each of the magnetic plates 21 is provided with an opening 22 bored in its central portion to correspond to the opening 12 of the induction coil 10, and wrapped with a shield 70 around its surface not facing to the induction stages 13.

Therefore, with the induction coils 10 densely wound and successively arrayed, and with at least one magnetic element located at a position to correspond to a maximal surface of the induction stages, not only is the mutual interaction between the induction stages and the magnetic plates augmented, but the direction-changing shock caused by the magnetic field is lowered when the magnetic plates pass the interface of the induction stages. That is, a high voltage can be created in a same unit area or kinetic energy can be created by a low current, with a minimal bulk to obtain a maximal density of the induction coils, achieving a smooth operation and providing a high efficient energy shift for a generator or a motor.

While the preferred embodiment of the invention has been described above, it will be recognized and understood that various modifications may be made therein and the appended claims are intended to cover all such modifications that may fall within the spirit and scope of the invention.

What is claimed is:

1. A high efficient magnetic energy shifting device composed of at least a magnetism unit, said magnetism unit comprising:
plural induction coil sets respectively provided with a plurality of individual coils formed by having wire coaxially wound in a same preset direction, an opening formed in a center of said individual coils, an induction stage formed around surface of said individual coils, said induction coils successively arrayed and fixed stably together by positioning elements; and
at least a magnetic element provided with a plurality of magnetic plates continuously arrayed and respectively corresponding to one side of said induction portion of said induction coil sets.

2. The high efficient magnetic energy shifting device as claimed in claim 1, wherein said magnetism unit is connected to a driving device.

3. The high efficient magnetic energy shifting device as claimed in claim 2, wherein said driving device is connected to a central axis of said magnetism unit by means of a shaft.

4. The high efficient magnetic energy shifting device as claimed in claim 2, wherein said driving device is installed around an outer circumference of said magnetism unit.

5. The high efficient magnetic energy shifting device as claimed in claim 1, wherein said induction coil sets are successively arrayed around said central axis of said magnetism unit, said magnetic element exactly facing to said induction stages of said induction coils to enable said magnetism unit shaped as a toroid.

6. The high efficient magnetic energy shifting device as claimed in claim 1, wherein said magnetic pieces are made of permanent magnet and formed similar to a shape corresponding to said induction stage.

7. The high efficient magnetic energy shifting device as claimed in claim 1, wherein said magnetic element has its outer surface wrapped with a shield that is made of metal so as to magnetically concentrate on said induction stage of said induction coils.

8. The high efficient magnetic energy shifting device as claimed in claim 5, wherein plural said magnetism units are overlaid together along said central axis.

9. The high efficient magnetic energy shifting device as claimed in claim 5, wherein plural said magnetism units are coaxially installed into a small circle and a large circle around said central axis on a same level.

10. The high efficient magnetic energy shifting device as claimed in claim 8 or 9, wherein said induction coils and said magnetic pieces are alternately disposed to form an alternate angle between two adjacent of said induction coils and said magnetic piece so as to save dynamic energy.

11. The high efficient magnetic energy shifting device as claimed in claim 1, wherein two corresponding sides of each of said induction coil set are respectively correlated to one of said magnetic pieces.

12. The high efficient magnetic energy shifting device as claimed in claim 1, wherein four sides of each of said induction coil are respectively correlated to one of said magnetic pieces

13. The high efficient magnetic energy shifting device as claimed in claim 5, wherein said induction coils are longitudinally installed around said central axis to enable their openings to mutually correspond to one another.

14. The high efficient magnetic energy shifting device as claimed in claim 5, wherein said induction coils are longitudinally installed around said central axis to enable an included angle formed between two adjacent of said induction coils for accommodating a secondary induction coil, said magnetic element corresponding to openings of said induction coils and said secondary induction coils.

15. The high efficient magnetic energy shifting device as claimed in claim 11 or 12, wherein said magnetic pieces corresponding to a top and a bottom of said induction coils are fixed on a rotating disc and a first isolating board, said induction coils fixed on a second isolating board.

16. The high efficient magnetic energy shifting device as claimed in claim 1, wherein each of said induction coil sets is provided with an individual coil formed by having wire coaxially and longitudinally wound in a same direction to become a slender ellipse.

17. The high efficient magnetic energy shifting device as claimed in claim 1, wherein each of said induction coils is provided with an individual coil formed by having wire coaxially and longitudinally wound in a same direction to become a rectangle.
